(19) United States
(12) Patent Application Publication
(10) Pub. No.: US 2022/0090505 A1
(43) Pub. Date: Mar. 24, 2022

(54) AIRFOIL HAVING CAVITY INSERT TO SEPARATE FLOW

(71) Applicant: GENERAL ELECTRIC COMPANY, Schenectady, NY (US)

(72) Inventors: Jonathon Farmer, Newport, KY (US); Ricardo Caraballo, Maineville, OH (US)

(73) Assignee: GENERAL ELECTRIC COMPANY, SCHENECTADY, NY (US)

(21) Appl. No.: 17/027,884

(22) Filed: Sep. 22, 2020

(51) Int. Cl. F01D 5/18; F01D 5/28

(52) U.S. Cl. CPC F01D 5/188; F05D 2220/32; F01D 5/282

(57) ABSTRACT

According to various embodiments, an airfoil includes an outer wall defining an airfoil body surrounding at least one cavity and a removable insert including at least one mating feature for coupling the removable insert with the airfoil body between a first location within the at least one cavity and a second location within the at least one cavity. The removable insert is free of openings and separates a first air flow path from a second air flow path through the at least one cavity. Vanes and gas turbine engines including the airfoil are also disclosed.

### FEDERALLY SPONSORED RESEARCH STATEMENT

This invention was made with United States Government support. The Government has certain rights in this invention.

### FIELD

This disclosure relates to turbine airfoils and, more particularly, to turbine airfoils having inserts to separate aft and forward flow through the same.

### BACKGROUND

Many current composite airfoils include an integrated rib within the airfoil cavity, which divides the cavity into two cavities, enabling the formation of two separate air paths. The integrated rib may also serve as an impingement surface to receive cooling air and direct the coolant in the impingement jet arrays against the outer wall to transfer energy from the walls to the fluid, thereby cooling the wall.

However, the inclusion of an integrated rib can introduce challenges. For example, because turbine airfoils typically include cooling holes for cooling, a certain amount of clearance to the integrated rib is required to enable the cooling holes to be formed within the turbine airfoil, thereby imposing geometric constraints on the cavity and in the cooling hole pattern. The formation of an integrated rib can also increase the complexity of the formation of the airfoil.

Accordingly, the need exists for alternative airfoil designs that enable simplification of manufacture and flexibility of design.

### SUMMARY

Various embodiments disclosed herein meet these needs by providing airfoils including a removable insert to separate a cavity of the airfoil into a first air flow path and a second air flow path. Because the separation between the first and second air flow paths is created by the removable insert instead of an integral rib formed within the cavity, geometric constraints on the cavity can be reduced, thereby enabling greater design flexibility. For example, the cavity may be moved toward the leading edge of the airfoil and the outer wall surrounding the cavity may be thickened to provide increased mechanical strength. Additionally, manufacture of the airfoil can be simplified by enabling a single cavity to be formed without the need to form an integrated rib. Additional features and advantages will be described in greater detail below.

According to a first aspect disclosed herein, an airfoil comprises an outer wall defining an airfoil body surrounding at least one cavity; and a removable insert including at least one mating feature for coupling the removable insert with the airfoil body between a first location within the at least one cavity and a second location within the at least one cavity, wherein the removable insert is free of openings and separates a first air flow path from a second air flow path through the at least one cavity.

According to a second aspect disclosed herein, an airfoil comprises the airfoil of the preceding aspect, wherein the removable insert is made of a metal material.

According to a third aspect disclosed herein, an airfoil comprises the airfoil according to any preceding aspect, wherein the metal material is a high temperature capable alloy.

According to a fourth aspect disclosed herein, an airfoil comprises the airfoil according to any preceding aspect, wherein the airfoil is a composite airfoil.

According to a fifth aspect disclosed herein, an airfoil comprises the airfoil according to any preceding aspect, wherein the airfoil comprises at least one mating feature within the cavity of the airfoil that is the inverse of the at least one mating feature of the removable insert.

According to a sixth aspect disclosed herein, an airfoil comprises the airfoil according to any preceding aspect, wherein the at least one mating feature within the cavity is a female mating feature and the at least one mating feature of the removable insert is a male mating feature.

According to a seventh aspect disclosed herein, an airfoil comprises the airfoil according to any preceding aspect, wherein the removable insert is non-structural.

According to an eighth aspect disclosed herein, an airfoil comprises the airfoil according to any preceding aspect, the airfoil body comprising a suction side and a pressure side which extend from a leading edge to a trailing edge of the airfoil body, wherein the removable insert extends from the suction side to the pressure side within the cavity.

According to a ninth aspect disclosed herein, an airfoil comprises the airfoil according to any preceding aspect, wherein there is no internal fluid communication between the first air flow path and the second air flow path through the cavity.

According to a tenth aspect disclosed herein, a turbine engine comprises a fan section, a high pressure compressor, a combustion section, and a turbine section in serial flow arrangement to define an engine centerline, wherein at least one of the high pressure compressor and the turbine section includes an airfoil comprising: an outer wall defining an airfoil body surrounding at least one cavity; and a removable insert including at least one mating feature for coupling the removable insert with the airfoil body between a first location within the at least one cavity and a second location within the at least one cavity, wherein the removable insert is free of openings and separates a first air flow path from a second air flow path through the at least one cavity.

According to an eleventh aspect disclosed herein, a turbine engine comprises the turbine engine according to the tenth aspect, wherein the removable insert is made of a metal material.

According to a twelfth aspect disclosed herein, a turbine engine comprises the turbine engine according to the eleventh aspect, wherein the metal material is a high temperature capable alloy.

According to a thirteenth aspect disclosed herein, a turbine engine comprises the turbine engine according to any of the tenth through twelfth aspects, wherein the airfoil is a composite airfoil.

According to a fourteenth aspect disclosed herein, a turbine engine comprises the turbine engine according to any of the tenth through thirteenth aspects, wherein the airfoil comprises at least one mating feature within the cavity of the airfoil that is the inverse of the at least one mating feature of the removable insert.

According to a fifteenth aspect disclosed herein, a turbine engine comprises the turbine engine according to any of the tenth through fourteenth aspects, wherein the at least one mating feature within the cavity is a female mating feature and the at least one mating feature of the removable insert is a male mating feature.

According to a sixteenth aspect disclosed herein, a turbine engine comprises the turbine engine according to any of the tenth through fifteenth aspects, wherein the removable insert is non-structural.

According to a seventeenth aspect disclosed herein, a turbine engine comprises the turbine engine according to any of the tenth through sixteenth aspects, wherein the airfoil body comprises a suction side and a pressure side which extend from a leading edge to a trailing edge of the airfoil body, and wherein the removable insert extends from the suction side to the pressure side within the cavity.

According to an eighteenth aspect disclosed herein, a turbine engine comprises the turbine engine according to any of the tenth through seventeenth aspects, wherein there is no internal fluid communication between the first air flow path and the second air flow path through the cavity.

According to a nineteenth aspect disclosed herein, a turbine engine comprises the turbine engine according to any of the tenth through eighteenth aspects, wherein an adhesive or sealant secures the removable insert at the first and second locations within the cavity.

According to a twentieth aspect disclosed herein, a turbine engine comprises the turbine engine according to any of the tenth through nineteenth aspects, wherein the removable insert has a thickness of from 0.3 mm to 2.5 mm.

Additional features and advantages of the embodiments disclosed herein will be set forth in the detailed description, which follows, and in part will be readily apparent to those skilled in the art from that description or recognized by practicing the disclosed embodiments as described herein, including the detailed description which follows, the claims, as well as the appended drawings.

It is to be understood that both the foregoing general description and the following detailed description present embodiments intended to provide an overview or framework for understanding the nature and character of the claimed embodiments. The accompanying drawings are included to provide further understanding, and are incorporated into and constitute a part of this specification. The drawings illustrate various embodiments of the disclosure, and together with the description serve to explain the principles and operations thereof.

### BRIEF DESCRIPTION OF THE DRAWINGS

FIG. 1 illustrates a cross-sectional view of a gas turbine engine having an airfoil according to one or more embodiments shown and described herein;

FIG. 2 illustrates an enlarged cross-sectional view of a turbine of the gas turbine engine of FIG. 1;

FIG. 3A illustrates a cross-sectional view of an airfoil of the turbine gas engine of FIG. 1 according to one or more embodiments shown and described herein;

FIG. 3B illustrates a cross-sectional view of another airfoil according to one or more embodiments shown and described herein;

FIG. 3C illustrates a cross-sectional view of the airfoil of FIG. 3A with the removable insert removed according to one or more embodiments shown and described herein;

FIG. 3D illustrates a cross-sectional view of the airfoil of FIG. 3B with the removable insert removed according to one or more embodiments shown and described herein; and

FIG. 4 illustrates a removable insert removed from an airfoil according to one or more embodiments shown and described herein.

### DETAILED DESCRIPTION

Reference will now be made in detail to the present preferred embodiments of the present disclosure, examples of which are illustrated in the accompanying drawings. Whenever possible, the same reference numerals will be used throughout the drawings to refer to the same or like parts. However, this disclosure may be embodied in many different forms and should not be construed as limited to the embodiments set forth herein.

Ranges can be expressed herein as from “about” one particular value, and/or to “about” another particular value. When such a range is expressed, another embodiment includes from the one particular value and/or to the other particular value. Similarly, when values are expressed as approximations, for example by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

As used herein, the singular forms “a,” “an” and “the” include plural referents unless the context clearly dictates otherwise. Thus, for example, reference to “a” component includes aspects having two or more such components, unless the context clearly indicates otherwise.

Various embodiments described herein include an airfoil comprising an outer wall defining an airfoil body surrounding at least one cavity and a removable insert including at least one mating feature for coupling the removable insert with the airfoil body between a first location within the at least one cavity and a second location within the at least one cavity. The removable insert is free of openings and separates a first air flow path from a second air flow path through the at least one cavity, thereby providing for separation of the air flow paths while reducing manufacturing complexity of the airfoil, as will be described in greater detail below.

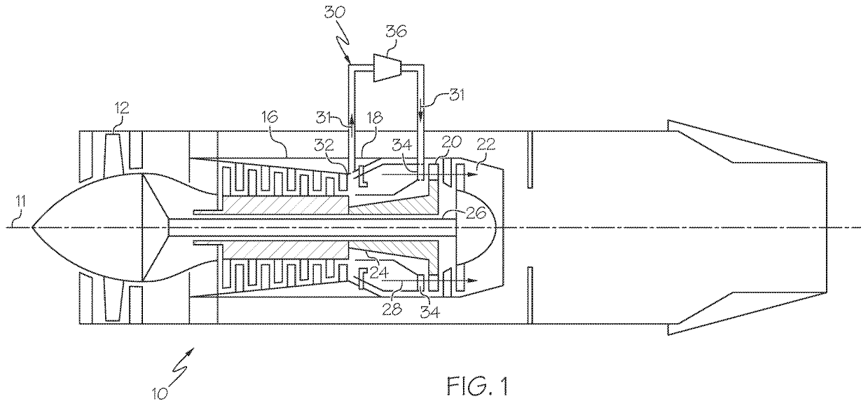

Illustrated in FIG. 1 is an airfoil constructed in accordance with various embodiments as generally indicated as 100 in a gas turbine engine 10. The gas turbine engine 10 is circumferentially disposed about an engine centerline 11 and has, in serial flow relationship, a fan section 12, a high pressure compressor 16, a combustion section 18, a high pressure turbine 20, and a low pressure turbine 22. The combustion section 18, the high pressure turbine 20, and the low pressure turbine 22 are often referred to as the hot section of the engine 10.

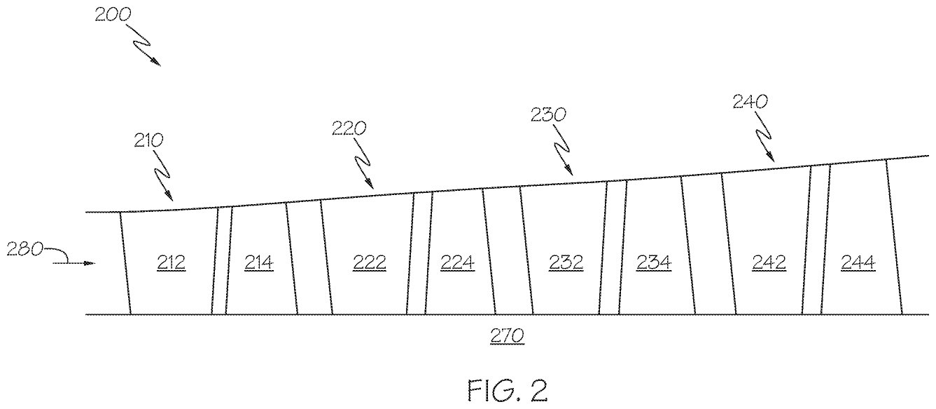

A high pressure rotor shaft 24 connects, in driving relationship, the high pressure turbine 20 to the high pressure compressor 16 and a low pressure rotor shaft 26 drivingly connects the low pressure turbine 22 to the fan section 12. Fuel is burned in the combustion section 18 producing a combustion gas flow 28, which is directed through the high pressure turbine 20 and the low pressure turbine 22 to power the engine 10. A cooling air supply 30 provides cooling air 31 from a compressor stage of the engine 10 such as a bleed at a compressor discharge 32 to a downstream element of the hot section, such as the turbine inlet guide vane 34. In embodiments, the pressure of the cooling air 31 taken from the compressor discharge 32 may be boosted by an optional supplemental compressor 36. FIG. 2 shows a schematic diagram of a turbine 200 that includes a first stage 210, a second stage 220, a third stage 230, and a fourth stage 240. Although the embodiment shown in FIG. 2 includes four stages, it is contemplated that any number of stages may be included in the turbine 200.

As shown in FIG. 2, the first stage 210 includes a number of circumferentially spaced first stage nozzles 212 and first stage blades 214. The first stage blades 214 are mounted on a turbine rotor 270. The first stage nozzles 212 are circumferentially spaced one from the other and fixed about an axis of the turbine rotor 270. Similarly, the second stage 220 includes a number of circumferentially spaced second stage nozzles 222 and second stage blades 224 mounted on the turbine rotor 270, the third stage 230 includes a number of circumferentially spaced third stage nozzles 232 and third stage blades 234 mounted on the turbine rotor 270, and the fourth stage 240 includes a number of circumferentially spaced fourth stage nozzles 242 and fourth stage blades 244 mounted on the turbine rotor 270. It will be appreciated that the nozzles and the blades lie in the hot path 280 of the turbine.

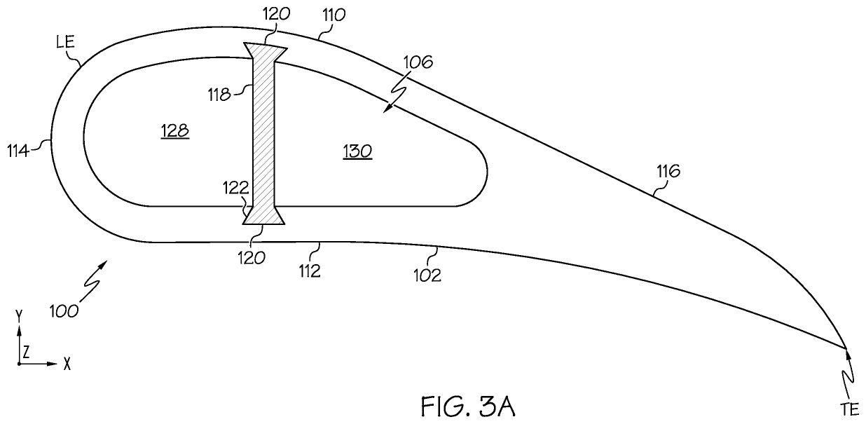

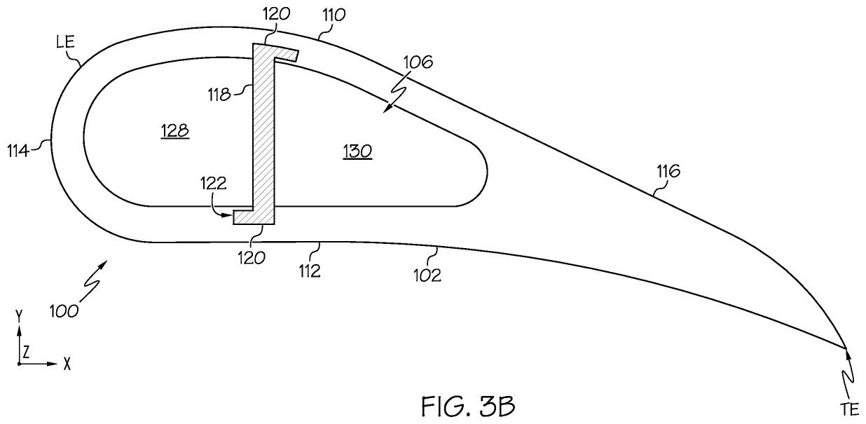

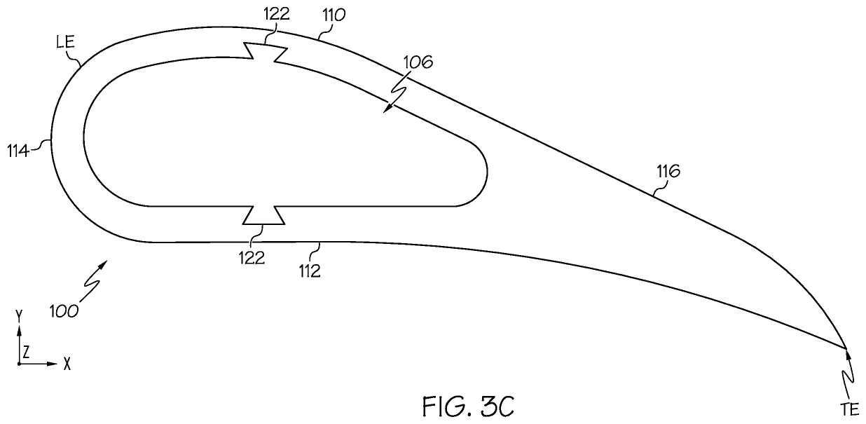

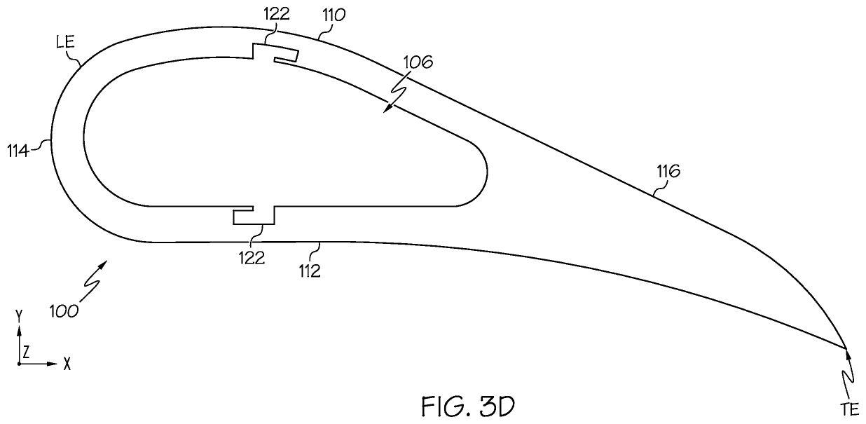

In various embodiments, each nozzle (e.g., the first stage nozzles 212, second stage nozzles 222, third stage nozzles 232, and fourth stage nozzles 242) includes an airfoil 100. Illustrated in FIGS. 3A and 3B is the airfoil 100 having an outer wall 102, which defines an airfoil body surrounding at least one generally radially extending cavity 106. The airfoil body has a highly curved suction side 110 (e.g., the top, or convex side) and a highly curved pressure side 112 (e.g., the bottom, or concave side), which meet at the leading edge LE upstream from the trailing edge TE. In various embodiments, the airfoil 100 generally has a leading edge portion 114 and a trailing edge portion 116. The leading edge LE and the trailing edge TE define a chord-wide direction, and each extend in a span-wise direction (along the Z-axis in FIGS. 3A and 3B).

In embodiments, the outer wall 102 has a ratio of a maximum thickness of the outer wall 102 to a minimum thickness of the outer wall 102 of from 2.00 to 2.50. For example, the ratio of the maximum thickness of the outer wall 102 to the minimum thickness of the outer wall 102 can be from 2.00 to 2.50, from 2.00 to 2.40, from 2.00 to 2.30, from 2.00 to 2.20, from 2.00 to 2.10, from 2.03 to 2.50, from 2.03 to 2.40, from 2.03 to 2.30, from 2.03 to 2.20, from 2.03 to 2.10, from 2.04 to 2.50, from 2.04 to 2.40, from 2.04 to 2.30, from 2.04 to 2.20, or from 2.04 to 2.10, including any and all ranges and subranges within these ranges.

In various embodiments, the airfoil is a composite airfoil comprising a ceramic matrix composite (CMC) material, which is a non-metallic material having high temperature capability. Exemplary CMC materials that may be used include, by way of example and not limitation, silicon carbide, aluminum oxide, carbon, and the like. Ceramic fibers may be embedded within the matrix, such as reinforcing fibers including silicon carbide, aluminum oxide, or carbon fibers.

The airfoil 100 shown in FIGS. 3A and 3B also includes a removable insert 118 extending from the suction side 110 to the pressure side 112 within the cavity 106. In various embodiments, the removable insert 118 is non-structural and is formed independently of the airfoil 100. As used herein, the phrase “non-structural” means that the removable insert 118 is not expected to carry any significant aerodynamic or structural load of the airfoil during operation. Accordingly, the removable insert 118 includes at least one mating feature 120 for coupling the removable insert 118 with the airfoil body between a first location within the cavity 106 and a second location within the cavity 106. FIGS. 3C and 3D illustrate the airfoil 100 of FIGS. 3A and 3B, respectively, with the removable insert 118 removed. In FIG. 3A, the airfoil 100 includes an outwardly projecting, or male, mating feature 120 at each end that is received by a corresponding groove, or female, mating feature 122 within the cavity 106 of the airfoil 100 (as shown in FIG. 3C) that is the inverse of the male mating feature 120 and is fitted to couple to the male mating feature 120 of the removable insert 118. Although depicted in FIGS. 3A and 3C as having a dovetail shape, other shapes and configurations for the mating features 120, 122 are contemplated. For example, in FIG. 3B, the mating features 120 of the removable insert 118 are in the form of tabs that fold within mating features 122 in the form of slots of the outer wall to couple the removable insert 118 to the airfoil body, as can be seen in FIG. 3D. In addition, although FIGS. 3A-3D depict the removable insert 118 including male mating features 120 and the airfoil body including female mating features 122, in embodiments, the removable insert 118 may include female mating features and the airfoil body can include male mating features. Still other shapes and configurations are possible and contemplated.

In embodiments, an adhesive or other sealant may be used to secure the removable insert 118 at the first and second locations within the cavity 106. Suitable sealants can include, by way of example and not limitation, silicone rubber sealants or other sealants known and used in the art. Suitable adhesives include those known in the art, for example, thermosetting epoxy/resin-based adhesives and the like. In embodiments, an adhesive may be applied to one or both of the mating features 120, 122 to adhere the mating features 120, 122 together. Sealants may be used, for example, at each of the span-wise edges to provide a smooth surface along the face of the airfoil 100 and/or to secure the removable insert 118 within the cavity 106. For example, the removable insert 118 depicted in FIG. 3A may be inserted into the cavity 106 of the airfoil 100 by sliding the male mating feature 120 of the removable insert 118 into the female mating feature 122 within the cavity 106 in the Z-direction. A sealant may then be used to seal the edges of the mating feature 122, thereby preventing the removable insert from moving in the Z-direction during use of the airfoil 100.

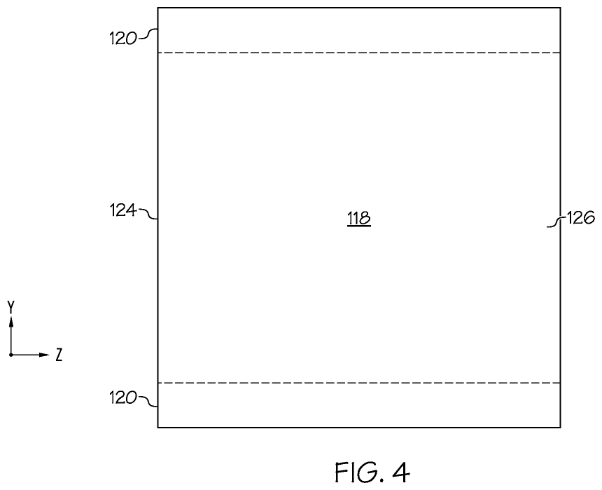

As shown in FIG. 4, in various embodiments, the removable insert 118 is in the form of a sheet having an outer perimeter 124 that extends around and defines a barrier region 126 of the removable insert 118. In embodiments, the removable insert 118, and specifically the barrier region 126 of the removable insert 118, is free of perforations, holes, or other openings that enable air flow through the surface of the removable insert 118. Accordingly, in various embodiments, such as the embodiment illustrated in FIGS. 3A-3B, the removable insert 118 creates and maintains separation between a first air flow path 128 and a second air flow path 130 through the cavity 106 of the airfoil 100. Put another way, in various embodiments, there is no internal fluid communication between adjacent air flow paths within the airfoil 100, and each of the air flow paths is fluidly independent from other air flow paths.

The removable insert 118 can be formed, for example, from a metal foil or other metallic piece. In various embodiments, a high temperature capable alloy may be used to form the removable insert. “High temperature capable alloy,” as used herein, means an alloy that is capable of maintaining its strength at temperatures from 500° C. to 1200° C., or higher. Suitable high temperature capable alloys include, by way of example and not limitation, stainless steel alloys with chrome, nickel, iron, molybdenum, cobalt, tungsten, silicon, rare earth elements, and combinations thereof. Other metals or lightweight materials may be used, provided they are able to withstand the thermal flows present within the cavity 106.

In embodiments, the removable insert 118 has a thickness of from about 0.3 mm to about 2.5 mm, from about 0.5 mm to about 2.5 mm, from about 1.0 mm to about 2.5 mm, from about 1.5 mm to about 2.5 mm, from about 2.0 mm to about 2.5 mm, from about 0.3 mm to about 2.0 mm, from about 0.5 mm to about 2.0 mm, from about 1.0 mm to about 2.0 mm, from about 1.5 mm to about 2.0 mm, from about 0.3 mm to about 1.5 mm, from about 0.5 mm to about 1.5 mm, from about 1.0 mm to about 1.5 mm, from about 0.3 mm to about 1.0 mm, from about 0.5 mm to about 1.0 mm, or from about 0.3 mm to about 0.5 mm, including any and all ranges and subranges within these ranges. The removable insert 118 may have a width in the span-wise direction (in the Z-direction shown in FIGS. 3A-3D and 4) of less than or equal to the span of the cavity 106.

The two air flow paths 128 and 130 can be arranged in any formation within the cavity 106 and are dedicated to supply cooling air to the cavity 106. Each of the air flow paths 128 and 130 forms part of a corresponding air flow circuit with air flow paths of adjacent airfoils, through which cooling air is flowed. It should be appreciated that the respective geometries of each individual air flow path within the airfoil 100 as shown is exemplary, and not meant to limit the airfoil to the number of air flow paths, their geometries, dimensions, or positions as shown. For example, two, three, or more air flow paths can be present within the airfoil 100, depending on the particular embodiment.

In embodiments, the airfoil 100 can be manufactured by forming the airfoil body including an outer wall defining a cavity. One or more mating features may be formed within the cavity. The airfoil body may be formed by any method known and used in the art, such as methods for forming airfoil bodies from composites, or the like. The mating features may be formed during formation of the airfoil body, or may be formed following the formation of the body, such as by removing a portion of the airfoil body to form the mating features. In various embodiments, the removable insert is formed independent of the airfoil body, and may be formed according to any method known and used in the art. For example, sheet metal forming processes may be used to cut and shape the removable insert from a supply of metal.

In various embodiments, the removable insert is inserted into the cavity and coupled to the airfoil body via the mating features. For example, male mating features of the removable insert extending outward from the removable insert may be inserted into the grooved female mating features of the cavity. Adhesive may be used to secure the removable insert within the mating features of the cavity. In embodiments, one or more sealants may be used to seal the removable insert within the cavity, such as by sealing an edge of the mating features to provide a smooth surface on the edge of the airfoil.

In embodiments, the removable insert may be replaced by removing the removable insert and inserting a new removable insert into the cavity. For example, a damaged, broken, or otherwise defective removable insert may be removed from the airfoil and replaced with a new removable insert to repair the airfoil without the need to replace the entire airfoil.

In various embodiments described herein, the use of an independent, removable insert can lead to the reduction of the geometric restraints on the cavity, because clearance to enable machining of holes in the airfoil wall is not required. The reduction of geometric constraints can, in turn, enable the wishbone to be moved in the direction of the leading edge LE, thereby enabling the outer wall 102 to be thicker, particularly in the trailing edge portion 116. Additionally, a thicker outer wall 102 can enable improved handling of mechanical loading. Accordingly, by eliminating the need to provide clearance to form cooling holes in the airfoil wall, additional cavity geometries and cooling hole patterns become possible as compared to those in conventional airfoils and handling of mechanical loading can be improved.

Moreover, in various embodiments, the use of a removable insert can reduce manufacturing complexity, as well as provide for simplified repair of the airfoil. For example, in conventional airfoils, a damaged integrated rib can require the entire airfoil to be replaced, particularly because damage to the rib can impact the structural integrity of the airfoil. However, in various embodiments, damage to the removable insert can be repaired by replacing the damaged insert with a new removable insert. Accordingly, both the cost and the complexity of repairing the airfoil can be reduced.

Further aspects of the invention are provided by the subject matter of the following clauses:

1. An airfoil comprising: an outer wall defining an airfoil body surrounding at least one cavity; and a removable insert including at least one mating feature for coupling the removable insert with the airfoil body between a first location within the at least one cavity and a second location within the at least one cavity, wherein the removable insert is free of openings and separates a first air flow path from a second air flow path through the at least one cavity.

2. The airfoil of any preceding clause, wherein the removable insert is made of a metal material.

3. The airfoil of any preceding clause, wherein the metal material is a high temperature capable alloy.

4. The airfoil of any preceding clause, wherein the airfoil is a composite airfoil.

5. The airfoil of any preceding clause, wherein the airfoil comprises at least one mating feature within the cavity of the airfoil that is the inverse of the at least one mating feature of the removable insert.

6. The airfoil of any preceding clause, wherein the at least one mating feature within the cavity is a female mating feature and the at least one mating feature of the removable insert is a male mating feature.

7. The airfoil of any preceding clause, wherein the removable insert is non-structural.

8. The airfoil of any preceding clause, the airfoil body comprising a suction side and a pressure side which extend from a leading edge to a trailing edge of the airfoil body, wherein the removable insert extends from the suction side to the pressure side within the cavity.

9. The airfoil of any preceding clause, wherein there is no internal fluid communication between the first air flow path and the second air flow path through the cavity.

10. A turbine engine comprising a fan section, a high pressure compressor, a combustion section, and a turbine section in serial flow arrangement to define an engine centerline, wherein at least one of the high pressure compressor and the turbine section includes an airfoil comprising: an outer wall defining an airfoil body surrounding at least one cavity; and a removable insert including at least one mating feature for coupling the removable insert with the airfoil body between a first location within the at least one cavity and a second location within the at least one cavity, wherein the removable insert is free of openings and separates a first air flow path from a second air flow path through the at least one cavity.

11. The turbine engine of any preceding clause, wherein the removable insert is made of a metal material.

12. The turbine engine of any preceding clause, wherein the metal material is a high temperature capable alloy.

13. The turbine engine of any preceding clause, wherein the airfoil is a composite airfoil.

14. The turbine engine of any preceding clause, wherein the airfoil comprises at least one mating feature within the cavity of the airfoil that is the inverse of the at least one mating feature of the removable insert.

15. The turbine engine of any preceding clause, wherein the at least one mating feature within the cavity is a female mating feature and the at least one mating feature of the removable insert is a male mating feature.

16. The turbine engine of any preceding clause, wherein the removable insert is non-structural.

17. The turbine engine of any preceding clause, the airfoil body comprising a suction side and a pressure side which extend from a leading edge to a trailing edge of the airfoil body, wherein the removable insert extends from the suction side to the pressure side within the cavity.

18. The turbine engine of any preceding clause, wherein there is no internal fluid communication between the first air flow path and the second air flow path through the cavity.

19. The turbine engine of any preceding clause, wherein an adhesive or sealant secures the removable insert at the first and second locations within the cavity.

20. The turbine engine of any preceding clause, wherein the removable insert has a thickness of from 0.3 mm to 2.5 mm.

It will be apparent to those skilled in the art that various modifications and variations can be made to embodiment of the present disclosure without departing from the spirit and scope of the disclosure. Thus, it is intended that the present disclosure cover such modifications and variations provided they come within the scope of the appended claims and their equivalents.

1. An airfoil comprising:
an outer wall defining an airfoil body surrounding at least one cavity; and
a removable insert including at least one mating feature for coupling the removable insert with the airfoil body between a first location within the at least one cavity and a second location within the at least one cavity, wherein the removable insert is free of openings and separates a first air flow path from a second air flow path through the at least one cavity,
wherein the removable insert is made of a metal material; and
wherein the airfoil comprises at least one mating feature within the cavity of the airfoil that is the inverse of the at least one mating feature of the removable insert.

2. (canceled)

3. The airfoil according to claim 1, wherein the metal material is a high temperature capable alloy.

4. The airfoil according to claim 1, wherein the airfoil is a composite airfoil.

5. (canceled)

6. The airfoil according to claim 1, wherein the at least one mating feature within the cavity is a female mating feature and the at least one mating feature of the removable insert is a male mating feature.

7. The airfoil according to claim 1, wherein the removable insert is non-structural.

8. The airfoil according to claim 1, the airfoil body comprising a suction side and a pressure side which extend from a leading edge to a trailing edge of the airfoil body, wherein the removable insert extends from the suction side to the pressure side within the cavity.

9. The airfoil according to claim 1, wherein there is no internal fluid communication between the first air flow path and the second air flow path through the cavity.

10. A turbine engine comprising a fan section, a high pressure compressor, a combustion section, and a turbine section in serial flow arrangement to define an engine centerline, wherein at least one of the high pressure compressor and the turbine section includes an airfoil comprising:
an outer wall defining an airfoil body surrounding at least one cavity; and
a removable insert including at least one mating feature for coupling the removable insert with the airfoil body between a first location within the at least one cavity and a second location within the at least one cavity, wherein the removable insert is free of openings and separates a first air flow path from a second air flow path through the at least one cavity,
wherein the removable insert is made of a metal material; and
wherein the airfoil comprises at least one mating feature within the cavity of the airfoil that is the inverse of the at least one mating feature of the removable insert.

11. (canceled)

12. The turbine engine according to claim 10, wherein the metal material is a high temperature capable alloy.

13. The turbine engine according to claim 10, wherein the airfoil is a composite airfoil.

14. (canceled)

15. The turbine engine according to claim 10, wherein the at least one mating feature within the cavity is a female mating feature and the at least one mating feature of the removable insert is a male mating feature.

16. The turbine engine according to claim 10, wherein the removable insert is non-structural.

17. The turbine engine according to claim 10, the airfoil body comprising a suction side and a pressure side which extend from a leading edge to a trailing edge of the airfoil body, wherein the removable insert extends from the suction side to the pressure side within the cavity.

18. The turbine engine according to claim 10, wherein there is no internal fluid communication between the first air flow path and the second air flow path through the cavity.

19. The turbine engine according to claim 10, wherein an adhesive or sealant secures the removable insert at the first and second locations within the cavity.

20. The turbine engine according to claim 10, wherein the removable insert has a thickness of from 0.3 mm to 2.5 mm.
